(19) United States
(12) Patent Application Publication
(10) Pub. No.: US 2003/0156374 A1
(43) Pub. Date: Aug. 21, 2003

(54) Electronic overload trip for a low-voltage circuit breaker

(76) Inventors: Douglas Edwards, Knightdale, SC (US); Holger Hochgraef, Wusterhausen (DE); Jeffery C. Mizener, Air Drive, OH (US); Andreas Pancke, Berlin (DE)

Correspondence Address: HARNESS, DICKEY & PIERCE, P.L.C., P.O.BOX 8910, RESTON, VA, 20195, US

(21) Appl. No.: 10/258,855

(22) PCT Filed: Jun. 13, 2001
(86) PCT No.: PCT/DE01/02209

(30) Foreign Application Priority Data
Jun. 28, 2000 (DE) 100-32-655.2

(51) Int. Cl. H02H 3/00

(52) U.S. Cl. 361/94

(57) ABSTRACT

The overall characteristic curve for an overload trip should fall monotonically, which isn't always the case for certain choices of set values. According to the invention, the characteristic curve of an overload trip in the overload region (I), for a section of the curve situated before the short-delayed short-circuit region (II), may be set with the delay time (t_{sdi}), which is independent of current and dependent on the short delay time (t_{sd}) and which is at least as big as the short delay time (t_{sd}). The above is particularly advantageous in the case of current measurement by means of Rogowski coils.

The invention relates to an electronic overcurrent release for a low-voltage circuit breaker having a characteristic which is subdivided into an overload area, a short-delay short-circuit area and an undelayed short-circuit area by means of settings comprising the response current I_{R}, a degree of inertia t_{R}, the short-delay short-circuit current I_{sd}, the short delay time t_{sd} and the undelayed short-circuit current Iᵢ.

Circuit breakers are used in electrical systems to protect the downstream loads as well as the system and, in the end, the circuit breakers themselves, against overloading and short circuits. Connection of the load outgoers to their own circuit breaker, and connection of a number of outgoers to a higher-level circuit breaker etc., results in a tree-structure system of switches, which is the precondition for selective disconnection of a faulty outgoer. One condition in this case is that a number of switches do not switch at the same time, but only that switch which is arranged immediately upstream of the fault location. The switch in the next-higher level of the tree structure should switch off only when a fault cannot be coped with by this first switch.

This selectivity can in principle be achieved by current grading and/or time grading, that is to say the overcurrent releases are set to different response currents, and/or the delay times of the releases are staggered. The loads which form the lowest level in the tree structure have no delay, while each higher layer in the tree structure is given a respectively increased delay.

The overcurrent release settings are normally based on a tripping characteristic which is subdivided into the areas of overload, short-delay short circuit and undelayed short circuit. In this case, in general, it has been found that the overload characteristic satisfies the relationship I²t=constant. The definition of a response current I_{R} for the release and the degree of inertia of the overload characteristic t_{R}, which defines the upper limit of the tripping time tₐ for six times the rated current I_{R}, thus also results in definition of the constant. In accordance with the standards, the release should trip after at most 7200 seconds at 1.2 times the response current, and this provides the lower limit of the overload characteristic, that is to say a vertical characteristic part.

Toward higher current levels, the overload characteristic is bounded by the short-delay short-circuit characteristic, which defines a guaranteed delay time t_{sd} for a setting value I_{sd} for the current. The profile of the short-delay short-circuit characteristic may itself once again follow the relationship I²t=constant, but as a rule it is defined to be independent of current, so that this results in a horizontal characteristic part in the overall characteristic.

This is in turn bounded by the area of undelayed tripping, which is defined by a current value Iᵢ. Since there is no intended delay in this area, this time is governed solely by the sum of the tripping time, the current detection time and the switch operation time.

The profile of the overall characteristic should fall monotonically in order that each current value has a specific associated tripping time and in order to allow clear selectivity grading. Selectivity is achieved when the circuit breakers in various grading levels have tripping characteristics which are shifted in the direction of a higher current and/or a longer tripping time from one grading level to the next grading level, and which do not touch or cross in a common diagram. In practice, a certain minimum separation is required in order to avoid loss of selectivity in the event of unfavorable tolerances.

A monotonically falling overall characteristic is always ensured when the setting of the characteristic values I_{R}, t_{R}, I_{sd} and t_{sd} at the transition from the area of the overload characteristic to the area of the short-delay short-circuit tripping is a vertical line, along which the time decreases from the overload area to the area of short-delay short-circuit tripping.

For current measurement, as can be carried out using conventional current transformers with iron, the iron saturation results in a restricted measurement range, which automatically results in a monotonically falling characteristic with the normal settings.

However, if the response current I_{R} is chosen to be very small in comparison to the current I_{sd} for the short-delay short-circuit tripping, which corresponds to a wide dynamic range, then it is possible for the times in the area of the overload characteristic to become shorter than the short-delay tripping before this overload characteristic changes suddenly to the value for short-delay tripping. This means that the time increases at the transition from the overload area to the short-delay tripping area. A dynamic range such as this may be used, for example, when transposed conductor coils, whose measurement range is in theory unrestricted, are used instead of current transformers with iron. The use of transposed conductor coils for detecting current has been known for a long time, but has become particularly favored recently, see, for example, DE-U 94 21 240 or DE-C 195 23 725.

The described response of the release would mean that it would be impossible to use an intrinsically advantageous wide dynamic range, since it would be necessary to restrict the ratio of I_{R}/I_{sd} or to restrict the degree of inertia t_{R} for the overcurrent release. However, restrictions such as these could likewise result in the loss of the capability for selectivity grading.

The invention is based on the object of specifying an electronic overcurrent release for a low-voltage circuit breaker, which ensures that the overcurrent release has a monotonically falling overall characteristic throughout the entire current range.

According to the invention, the object is achieved by the features of claim 1. Expedient refinements are the subject matter of the dependent claims.

According to this, the characteristic of the overcurrent release in the overload area for a characteristic section which is located before the short-delay short-circuit area is reached can be set to a delay time t_{sdi} which is independent of current, is dependent on the short delay time t_{sd} and is at least of equal magnitude to the short delay time t_{sd}.

The delay time t_{sdi}, which is independent of current, may in this case be a value of the short-time delay t_{sd} increased by a predetermined percentage or by a constant value.

The overcurrent release can use the predetermined characteristic values to uniquely determine the current/time value pair for the transition from the overload characteristic falling at I²t=constant to the overload area which is independent of current. This value pair may now be set for each overcurrent release in the selectivity analysis such that the horizontally running characteristic sections are at the necessary minimum distance from one another. There is no need for the user to set this value pair, since the values are obtained from the existing setting values.

The invention will be explained in more detail in the following text using an exemplary embodiment. In the figures:

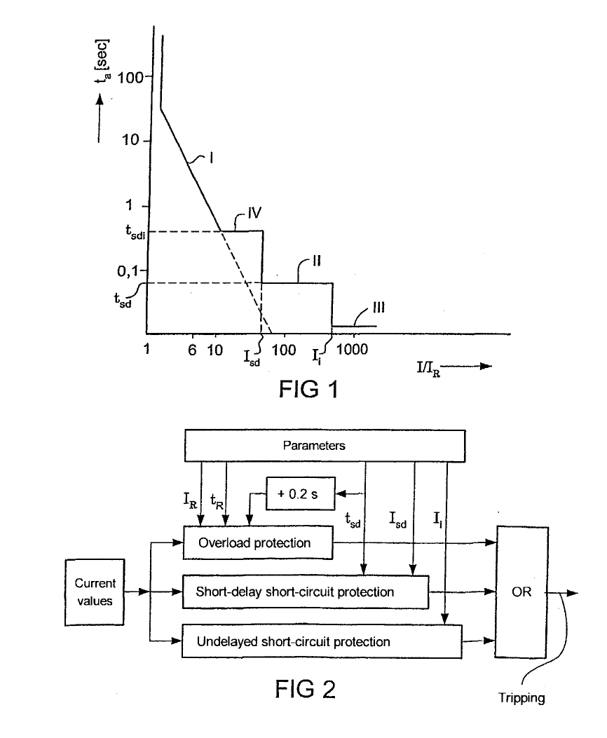

FIG. 1 shows the characteristic profile of an overcurrent release according to the invention, and

FIG. 2 shows the outline structure of such an overcurrent release.

FIG. 1 shows the characteristic profile of an electronic overcurrent release. The graph shows the tripping time tₐ plotted against the current I related to the response current I_{R}. In addition to being governed by the response current I_{R}, the characteristic is governed by the degree of inertia t_{R}, which is in this case defined by the tripping time tₐ at six times the response current I_{R}, as well as by the setting value for the short-delay short-circuit current I_{sd} and the associated short delay time t_{sd}. The start of the undelayed area is, furthermore, governed by the setting value for the undelayed short-circuit current Iᵢ. The initial vertical part of the characteristic is located, in accordance with IEC 60 947-2, between 1.05 and 1.2 times the response current I_{R}. The illustrated characteristic shape is obtained when the values are plotted on a log/log coordinate system.

Thus, initially, this results in three areas: the overload area I in which I²t=constant, and, as areas in which the delay time tₐ is independent of current, the area of short-delay short-circuit tripping II and the area of undelayed short-circuit tripping III.

If the setting value for the short-delay short-circuit current I_{sd} is set, as in the illustrated example, appropriately high in comparison to the response current I_{R}, as is possible when using transposed conductor coils for current measurement, then the characteristic in the overload area I still falls below the setting value for the short-delay short-circuit current I_{sd}. The characteristic would thus no longer be unique and could intersect a characteristic, which is located below the illustrated characteristic in the selectivity grading, of a circuit breaker in the next lower selectivity level. This would mean that selectivity no longer existed.

The presetting of a further parameter now ensures that the overload characteristic is always significantly above the short delay time t_{sd}. An overload area IV which is independent of current is thus set as an additional characteristic section, which connects the monotonically falling part of the overload area I to the area of short-delay short-circuit tripping II. The vertical positioning of the overload area IV which is independent of current takes place as a result of the addition of a constant time value, for example of 0.2 s, to the short-delay time t_{sd} to form a delay time t_{sdi} which is independent of current. This therefore once again allows selectivity with respect to downstream circuit breakers.

In the case of microprocessor-controlled releases, a pure software implementation is possible. A single WHEN check can be used to ensure that the overload protection does not trip in a shorter time than the short delay time t_{sd} plus a time value that has been set. The current/time value pair for the transition from the monotonically falling overload area I to the overload area IV which is independent of current can in any case be determined by the release itself in electronic overcurrent releases, so that there is no need to carry out any further adjustment.

FIG. 2 shows the operation of an overcurrent release on the basis of a structogram. In addition to the parameters comprising the response current I_{R}, the degree of inertia t_{R}, the short-delay short-circuit current I_{sd}, the short delay time t_{sd} and the undelayed short-circuit current Iᵢ, a further parameter is provided for the overload area IV, which is independent of current, for overload protection, and this further parameter is obtained from the setting value for the short delay time t_{sd} by addition to a constant time value, in this case 0.2 s.

1. An electronic overcurrent release for a low-voltage circuit breaker having a characteristic which is subdivided into an overload area (I), a short-delay short-circuit area (II) and an undelayed short-circuit area (III) by means of settings comprising the response current (I_{R}), a degree of inertia (t_{R}), the short-delay short-circuit current (I_{sd}), the short delay time (t_{sd}) and the undelayed short-circuit current (Iᵢ),
characterized
in that its characteristic in the overload area (I) for a characteristic section which is located before the short-delay short-circuit area (II) is reached can be set to a delay time (t_{sdi}), which is independent of current, is dependent on the short delay time (t_{sd}) and is at least of equal magnitude to the short delay time (t_{sd})

2. The overcurrent release as claimed in claim 1,
characterized
in that the delay time (t_{sdi}), which is independent of current in the overload area, is a value of the short delay time (t_{sd}) increased by a predetermined percentage of the short delay time (t_{sd}).

3. The overcurrent release as claimed in claim 1,
characterized
in that the delay time (t_{sdi}), which is independent of current in the overload area, is a value of the short delay time (t_{sd}) increased by a predetermined time.
